(19) United States
(12) Patent Application Publication
(10) Pub. No.: US 2023/0421729 A1
(43) Pub. Date: Dec. 28, 2023

(54) INFORMATION PROCESSING APPARATUS, METHOD, AND SYSTEM

(71) Applicant: TOYOTA JIDOSHA KABUSHIKI KAISHA, Toyota-shi (JP)

(72) Inventors: Yoshikazu JIKUHARA, Miyoshi-shi (JP); Yoshinori KANEMITSU, Tachikawa-shi (JP); Yurika TANAKA, Yokosuka-shi (JP); Keiichi UNO, Chita-gun (JP)

(73) Assignee: TOYOTA JIDOSHA KABUSHIKI KAISHA, Toyota-shi (JP)

(21) Appl. No.: 18/326,166

(22) Filed: May 31, 2023

(30) Foreign Application Priority Data
Jun. 28, 2022 (JP) 2022-103987

(51) Int. Cl. H04N 7/18; G06Q 50/30; G05D 1/00; G05D 1/10; G06Q 10/02

(52) U.S. Cl. CPC H04N 7/181; G06Q 50/30; G05D 1/0011; G05D 1/106; G06Q 10/02; B64U 2101/31

(57) ABSTRACT

An information processing apparatus acquires a first image that is obtained by capturing a boarding point of a first vehicle provided for a predetermined transport service, and transmits the first image to a user terminal of a user who is scheduled to get on board the first vehicle at the boarding point. The first image is captured by a drone. In a case where the drone is not allowed to fly, the first image is acquired from a plurality of captured images that are captured by a plurality of vehicle-mounted cameras mounted on a plurality of vehicles, each vehicle-mounted camera capturing the captured image every predetermined period of time that is associated with the vehicle-mounted camera in question.

### CROSS REFERENCE TO THE RELATED APPLICATION

This application claims the benefit of Japanese Patent Application No. 2022-103987, filed on Jun. 28, 2022, which is hereby incorporated by reference herein in its entirety.

### BACKGROUND

### Technical Field

The present disclosure relates to an information processing apparatus, a method, and a system.

### Description of the Related Art

There is disclosed provision of information in response to a request for an on-demand service that is a transport service that uses a vehicle, the information including a departure position, a destination, a traveling distance, a pickup time and the like (for example, Japanese Patent Laid-Open No. 2020-098650).

An aspect of the disclosure is aimed at providing an information processing apparatus, a method, and a system with which a user may be guided to a boarding point of a vehicle that is provided for a predetermined transport service and may be prevented from getting lost.

### SUMMARY

An aspect of the present disclosure is an information processing apparatus including a processor configured to:
acquire a first image that is obtained by capturing a boarding point of a first vehicle provided for a predetermined transport service, and
transmit the first image to a user terminal of a user who is scheduled to get on board the first vehicle at the boarding point.

Another aspect of the present disclosure is a method executed by a computer including:
acquiring a first image that is obtained by capturing a boarding point of a first vehicle provided for a predetermined transport service; and
transmitting the first image to a user terminal of a user who is scheduled to get on board the first vehicle at the boarding point.

Another aspect of the present disclosure is a system including:
a drone; and
an information processing apparatus, wherein
the information processing apparatus includes a processor configured to
   issue an instruction to the drone to move to a boarding point of a first vehicle provided for a predetermined transport service, and to capture the boarding point,
   acquire a first image obtained by the drone by capturing the boarding point, and
   transmit the first image to a user terminal of a user who is scheduled to get on board the first vehicle at the boarding point.

According to an aspect of the present disclosure, a user may be guided to a boarding point of a vehicle that is provided for a predetermined transport service, and may be prevented from getting lost.

### BRIEF DESCRIPTION OF THE DRAWINGS

FIG. 1 is a diagram illustrating an example of a system configuration of an on-demand bus system according to a first embodiment;

FIG. 2 is an example of a hardware configuration of a server;

FIG. 3 is a diagram illustrating an example of a functional configuration of the server;

FIG. 4 is an example of information that is held in a reservation information database in the server;

FIG. 5 is an example of information that is held in a vehicle captured image database in the server; and

FIG. 6 is an example of a flowchart of a captured image distribution process related to a boarding point by the server.

### DESCRIPTION OF THE EMBODIMENTS

An on-demand bus that is operated based on a request from a user is known. With an on-demand bus, a bus stop is not installed, and a boarding/alighting point is dynamically set based on requests from a plurality of users. Accordingly, for example, even when correctly arriving at the boarding point, a user may feel unsure whether the location is actually the boarding point or not. Furthermore, map information and the like may be different from a current situation due to not being updated, for example.

An aspect of the present disclosure is an information processing apparatus that transmits a boarding point capturing image to a user terminal that is carried by a user. More specifically, the information processing apparatus includes a processor configured to acquire a first image that is obtained by capturing a boarding point of a first vehicle provided for a predetermined transport service, and transmit the first image to a user terminal of a user who is scheduled to get on board the first vehicle at the boarding point.

The information processing apparatus may be a server, for example. However, the information processing apparatus is not limited to a server. The user terminal may be a smartphone, a tablet terminal, a personal computer (PC), a wearable terminal, or the like, for example. The processor of the information processing apparatus may be a processor such as a central processing unit (CPU), for example. The transport service may be a transport service for people, where a boarding point and a scheduled boarding time are determined at the time of reservation. More specifically, the transport service may be an on-demand bus, a taxi, a ride-sharing service, a vehicle dispatch service, or the like. The first vehicle may be a bus, a passenger car, an autonomous vehicle, or the like. The first image may be a captured image including the boarding point and its periphery.

According to the aspect of the present disclosure, the first image capturing the boarding point that is dynamically set in relation to the predetermined transport service is transmitted to the user terminal, and the user may check a state of the boarding point based on the first image. The user may thus be guided to the boarding point, and may be prevented from getting lost.

According to an aspect of the present disclosure, the processor may be configured to issue an instruction to a drone to move to the boarding point, and to capture the first image, and may be configured to acquire the first image from the drone. By causing the drone to move to the boarding point and capture an image of the boarding point, a more recent captured image of the boarding point may be acquired.

Furthermore, the processor may be configured to issue the instruction to the drone to capture the boarding point, in a case where a predetermined condition that allows flight of the drone is satisfied. In the case where the predetermined condition is not satisfied, the processor may be configured to take, as the first image, a latest captured image including the boarding point among a plurality of captured images captured by a plurality of vehicle-mounted cameras mounted on a plurality of vehicles. The information processing apparatus may include a storage. The plurality of captured images that are each captured by the vehicle-mounted camera every predetermined period of time that is associated with the vehicle-mounted camera in question may be transmitted from the vehicle to the information processing apparatus every predetermined period of time, and be held in the storage together with a capturing date/time and a capturing position. The predetermined condition that allows flight of the drone is that it is not nighttime and that it is not raining, for example.

There are restrictions regarding the drone; for example, the drone is not allowed to fly at nighttime, and is not allowed to fly when it is raining due to the possibility of being broken. Accordingly, there are cases where the drone is not able to capture the image of the boarding point. By using the captured image that is captured by the vehicle-mounted camera in a case where the drone is not able to capture the boarding point, relatively new information about the periphery of the boarding point may be provided to the user.

According to an aspect of the present disclosure, the information processing apparatus may further include the storage configured to hold each of the plurality of captured images together with the capturing date/time and the capturing position, the plurality of captured images being captured by the plurality of vehicle-mounted cameras mounted on the plurality of vehicles, each vehicle-mounted camera capturing the captured image every predetermined period of time that is associated with the each vehicle-mounted camera. In this case, the processor may be configured to acquire, as the first image, a latest captured image including the boarding point among the plurality of captured images held in the storage. Relatively new information about the periphery of the boarding point may thus be provided to the user even in a case where the drone is not used.

According to an aspect of the present disclosure, the processor may be configured to acquire the first image and to transmit the first image to the user terminal, in a case where a time that is a predetermined period before a scheduled boarding time of the first vehicle is reached. The predetermined period is set in a range of one hour to five minutes, for example. An image including the boarding point immediately before the user gets on board the first vehicle may thus be provided to the user.

As another aspect of the present disclosure, there may be specified a method executed by a computer including performing a process of the information processing apparatus described above. The method executed by the computer including acquiring a first image that is obtained by capturing a boarding point of a first vehicle provided for a predetermined transport service, and transmitting the first image to a user terminal of a user who is scheduled to get on board the first vehicle at the boarding point. Furthermore, as another aspect of the present disclosure, there may be specified a program for causing a computer to perform a process of the information processing apparatus described above.

Moreover, as another aspect of the present disclosure, there may be specified a system including a drone and the information processing apparatus described above. As another aspect of the present disclosure, there may be specified a non-transitory computer-readable recording medium for each program.

In the following, embodiments of the present disclosure will be described with reference to the drawings. The configuration of the embodiments described below are examples, and the present disclosure is not limited to the configuration of the embodiments.

### First Embodiment

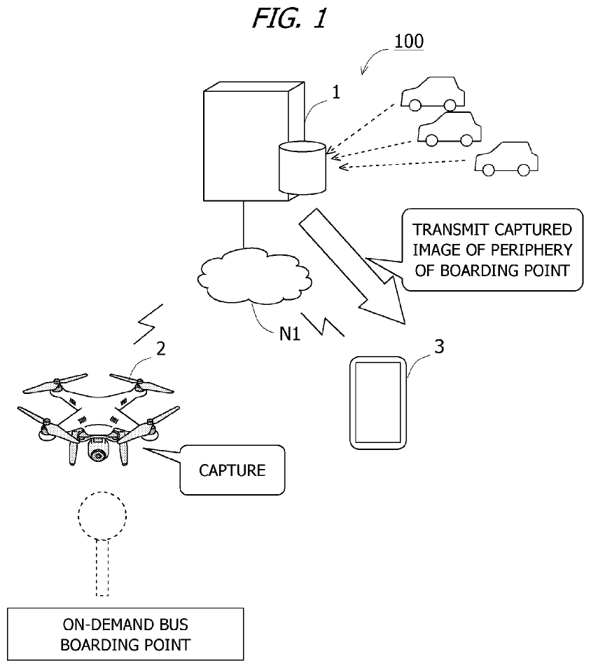

FIG. 1 is a diagram illustrating an example of a system configuration of an on-demand bus system 100 according to a first embodiment. The on-demand bus system 100 is a system that controls an on-demand bus that is operated in response to a request from a user. The on-demand bus system 100 includes a server 1, a drone 2, and a user terminal 3. The on-demand bus system 100 includes a plurality of drones 2 and a plurality of user terminals 3, but FIG. 1 extracts and illustrates one drone 2 and one user terminal 3.

The server 1, the drone 2, and the user terminal 3 are connected to a network N1, and are capable of communicating via the network N1. The network N1 is a public network such as the Internet, for example.

The user terminal 3 is a terminal where a client application program for using a service of the on-demand bus system 100 is installed. For example, a user of the user terminal 3 is enabled to use the service of the on-demand bus system 100, or in other words, an on-demand bus, by performing user registration in the on-demand bus system 100 through execution of the application program. In the following, a simple term “user” is assumed to indicate a user who owns the user terminal 3. Furthermore, in the following, a simple term “bus” is assumed to indicate the on-demand bus.

In the case of using the on-demand bus, the user transmits a boarding request to the server 1 using the user terminal 3. For example, information about a desired boarding date/time or a desired alighting date/time, a desired boarding point, and a desired alighting point is also transmitted to the server 1, together with the boarding request. When the boarding request is received from the user terminal 3, the server 1 determines a scheduled boarding date/time, a boarding point, and an alighting point based on the desired boarding date/time or the desired alighting date/time, the desired boarding point, and the desired alighting point from the user terminal 3 and the boarding request(s) from other user(s), and fixes a boarding reservation of the user. For example, a plurality of boarding points and alighting points may be set in advance for the on-demand bus and the user may select the desired boarding point and the desired alighting point, or the user may freely specify the desired boarding point and the desired alighting point.

The desired boarding date/time, the desired boarding point, and the desired alighting point of the user may be directly adopted as the scheduled boarding date/time, the boarding point, and the alighting point, but may be made different due to the boarding reservation(s) of other user(s). However, the scheduled boarding date/time, the boarding point, and the alighting point are set to positions and a time close to the desired boarding date/time, the desired boarding point, and the desired alighting point of the user.

When the reservation is fixed, the server 1 transmits reservation information to the user terminal 3, as a response to the boarding request. For example, the reservation information includes the scheduled boarding date/time, a scheduled alighting date/time, the boarding point, and the alighting point.

In the first embodiment, when a time that is a predetermined period before the scheduled boarding date/time of the boarding reservation is reached, the server 1 causes the drone 2 to move to the boarding point and to capture an image of the boarding point from above the boarding point. The predetermined period is freely set in a range of five minutes to one hour, for example. The server 1 receives a captured image of the boarding point from the drone 2, and transmits the same to the user terminal 3.

For example, in many cases, the drone 2 is prohibited from flying at nighttime, and is recommended not to fly when it is raining. Accordingly, there are cases when the drone 2 is not able to capture the image of the boarding point. In the first embodiment, the server 1 holds, in a storage unit, captured images that are captured by a plurality of vehicle-mounted cameras, mounted on a plurality of vehicles, in an immediately preceding period of time. In the case where the drone 2 is not allowed to fly, the server 1 transmits, to the user terminal 3, a latest image among images of the boarding point in the captured images from the vehicle-mounted cameras. Images of the boarding point include an image including the boarding point, and a captured image not including the boarding point but capturing the periphery of the boarding point, for example.

In the first embodiment, when a time that is a predetermined period before the scheduled boarding date/time of the boarding reservation is reached, a latest captured image of the boarding point among captured images that can be acquired by the server 1 is transmitted to the user terminal 3. Accordingly, the user of the user terminal 3 may grasp a state of the periphery of the boarding point from a relatively new captured image, and may arrive at the boarding point without getting lost.

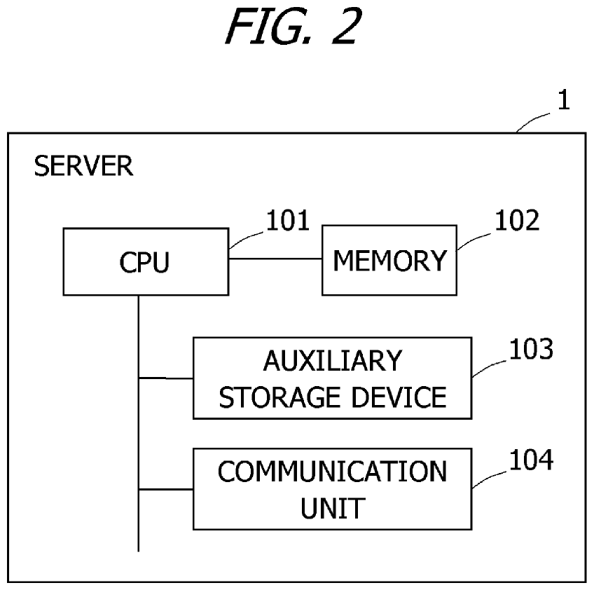

FIG. 2 is an example of a hardware configuration of the server 1. As hardware components, the server 1 includes a CPU 101, a memory 102, an auxiliary storage device 103, and a communication unit 104. The memory 102 and the auxiliary storage device 103 are each an example of a non-transitory computer-readable recording medium. The server 1 is an example of “information processing apparatus”.

The auxiliary storage device 103 stores various programs, and data that is used by the CPU 101 at the time of execution of each program. For example, the auxiliary storage device 103 is a hard disk drive (HDD), and a solid state drive (SSD). The programs held in the auxiliary storage device 103 include an operating system (OS), and a control program of the on-demand bus system 100, for example. The control program of the on-demand bus system 100 is a program for performing control processes related to reception of reservation, operation and the like of the on-demand bus, for example. The auxiliary storage device 103 is an example of “storage”.

The memory 102 is a main memory that provides a storage area and a work area where programs stored in the auxiliary storage device 103 are loaded, and that is used as a buffer, for example. The memory 102 includes semiconductor memories such as a read only memory (ROM) and a random access memory (RAM), for example.

The CPU 101 performs various processes by loading, into the memory 102, and executing the OS and various other programs held in the auxiliary storage device 103. The number of CPUs 101 is not limited to one, and there may be provided a plurality of CPUs 101. The CPU 101 is an example of “processor”.

The communication unit 104 is a module, such as local area network (LAN) card and an optical module, which connects a network cable and includes a circuit for signal processing. The communication unit 104 is not limited to a circuit that can be connected to a wired network, and may be a wireless signal processing circuit that is capable of processing a wireless signal of a wireless communication network such as WiFi. Additionally, the hardware configuration of the server 1 is not limited to the one illustrated in FIG. 2.

For example, the drone 2 includes a CPU, a memory, an auxiliary storage device, a wireless communication unit, a camera, a position acquisition unit, propellers, and a flight control unit. The CPU, the memory, and the auxiliary storage device are the same as the CPU 101, the memory 102, and the auxiliary storage device 103, respectively. The wireless communication unit is a wireless communication circuit that is compatible with a mobile communication method such as 5th generation (5G), 6G, 4G, and long term evolution (LTE), WiMAX, or a wireless communication method such as WiFi, for example. The position acquisition unit acquires the current position of the drone 2. The position acquisition unit is a global positioning system (GPS) receiver, for example. The flight control unit controls rotations and the like of the propellers, and controls flight of the drone 2. Additionally, the hardware configuration of the drone 2 is not limited to the configuration described above.

For example, the user terminal 3 is a smartphone, a tablet terminal, a PC, a wearable terminal, or the like. As hardware components, the user terminal 3 includes a CPU, a memory, an auxiliary storage device, a wireless communication unit, a touch panel display, and the like. The CPU, the memory, and the auxiliary storage device are the same as the CPU 101, the memory 102, and the auxiliary storage device 103, respectively. However, the auxiliary storage device of the user terminal 3 holds, in addition to the OS, the client application program of the on-demand bus system 100, for example. Like the wireless communication unit of the drone 2, the wireless communication unit of the user terminal 3 is a wireless communication circuit that is compatible with a mobile communication method such as 5G, 6G, 4G, and LTE, WiMAX, or a wireless communication method such as WiFi, for example. Additionally, the hardware configuration of the user terminal 3 is not limited to the configuration described above.

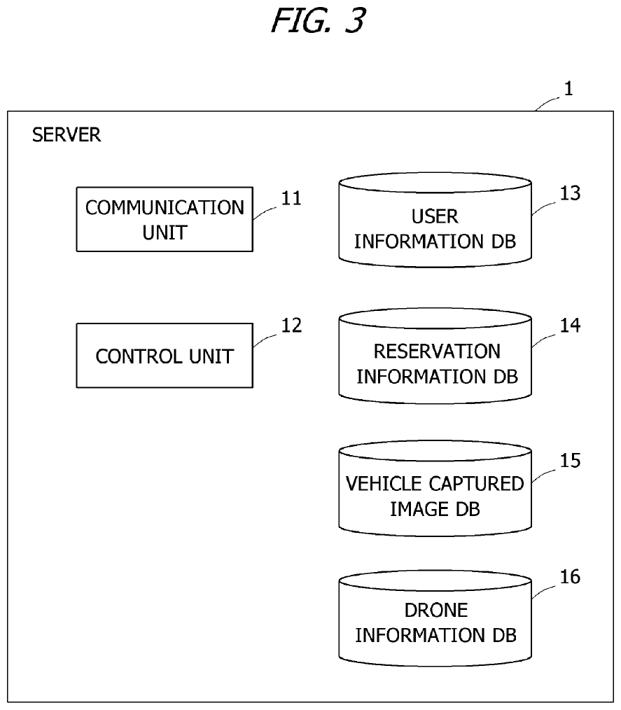

FIG. 3 is a diagram illustrating an example of a functional configuration of the server 1. As functional components, the server 1 includes a communication unit 11, a control unit 12, a user information DB 13, a reservation information DB 14, a vehicle captured image DB 15, and a drone information DB 16. Processes by the functional components are processes that are achieved by the CPU 101 of the server 1 executing the control program of the on-demand bus system 100 that is held in the auxiliary storage device 103.

The communication unit 11 is an interface to the network N1. The communication unit 11 outputs data that is received via the network N1 to the control unit 12. Furthermore, the communication unit 11 transmits data input from the control unit 12 to a predetermined apparatus via the network N1.

In the case where the boarding request is received from the user terminal 3 via the communication unit 11, the control unit 12 performs a boarding reservation reception process. For example, information about the desired boarding date/time or the desired alighting date/time, the desired boarding point, and the desired alighting point is also received together with the boarding request. In the boarding reservation reception process, the control unit 12 determines the bus that is to be dispatched, and determines the scheduled boarding date/time, the scheduled alighting date/time, the boarding point, and the alighting point based on the desired boarding date/time or the desired alighting date/time, the desired boarding point, and the desired alighting point, for example. Additionally, the method of determining the bus that is to be dispatched, or of determining the boarding point, the scheduled boarding date/time, the alighting point and the scheduled alighting date/time may be any known method, and is not limited to a specific method.

When the boarding point, the scheduled boarding date/time, the alighting point, and the scheduled alighting date/time are determined, the boarding reservation is fixed. When the boarding reservation is fixed, the control unit 12 transmits the reservation information to the user terminal 3 as a response to the boarding request.

The control unit 12 performs, in relation to each boarding reservation, a process of distributing the image of the boarding point to the user terminal 3. The process of distributing the image of the boarding point to the user terminal 3 will be referred to below as a boarding point image distribution process. In the boarding point image distribution process, first, in a case where a time that is a predetermined period before the scheduled boarding date/time is reached, the control unit 12 determines whether a flight condition that is a condition that allows flight of the drone is satisfied or not. The predetermined period based on which the time of start of the boarding point image distribution process is determined may be set as a fixed value in advance, or may be determined as appropriate based on a relationship between the boarding point and a position of the drone 2, for example. As the position of the drone 2, the position of the drone 2 that is closest to the boarding point, or a position of a home base of the drone 2 may be used, for example.

The flight condition for the drone is that it is a time slot other than nighttime, and that it is not raining, for example. Whether it is a time slot other than nighttime or not may be determined based on whether it is a time slot in the nighttime that is set in advance or not, whether a current time is a time between a sunset time of a current day and a sunrise time of a next day or not, or whether outside brightness in the periphery of the boarding point is smaller than a predetermined value or not, for example. Furthermore, whether it is raining or not may be determined based on weather radar information, live information about rain based on big data such as social network service (SNS), or the like.

The sunset time, the sunrise time, the outside brightness, and the weather radar information may be acquired from a service of distributing weather information, for example. The big data such as the SNS may be acquired from a big data analysis service, for example. However, the flight condition for the drone is not limited to those mentioned above, and may be that a wind speed is smaller than a predetermined value, for example.

In the case where the flight condition for the drone is satisfied, the control unit 12 refers to the drone information DB 16 described later, for example, and selects the drone 2 to be dispatched. The drone 2 to be dispatched may be the drone 2 that is closest to the boarding point, or a drone 2 that is randomly selected from the drones 2 in the home base, for example. The control unit 12 transmits, to the selected drone 2 via the communication unit 11, an instruction to move to the boarding point and to capture the image of the boarding point from above the boarding point. Then, when a captured image is received from the drone 2 that is dispatched, via the communication unit 11, the control unit 12 transmits the captured image to the user terminal 3. Then, the control unit 12 instructs the drone 2 that is dispatched to move to a predetermined position, via the communication unit 11. The predetermined position is the home base of the drone 2, or another capturing location (the boarding point of another boarding reservation), for example.

In the case where the flight condition for the drone is not satisfied, the control unit 12 acquires a latest captured image among captured images including the boarding point, from the vehicle captured image DB 15 described later, and transmits the captured image to the user terminal 3 via the communication unit 11.

The user information DB 13, the reservation information DB 14, the vehicle captured image DB 15, and the drone information DB 16 are created in a storage area in the auxiliary storage device 103. The user information DB 13 holds information about the user. Information about the user includes identification information of the user, contact information of the user, and the like, for example. The reservation information DB 14 holds information about the boarding reservation. The vehicle captured image DB 15 stores captured images captured by the vehicle-mounted cameras on a plurality of vehicles, and information related to the captured images. The drone information DB 16 stores information about the drone. Information about the drone includes identification information of the drone, a current position of the drone, and information indicating a state of standby or a state of executing an instruction, for example. Additionally, the functional configuration of the server 1 is not limited to the one illustrated in FIG. 3.

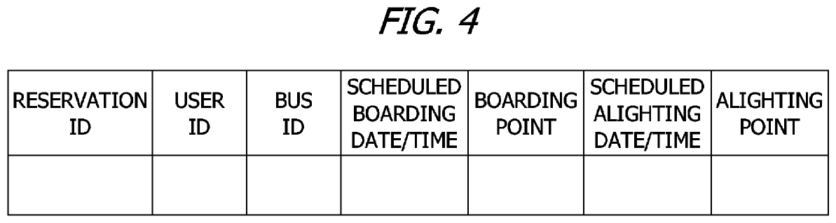

FIG. 4 is an example of the information that is held in the reservation information DB 14 in the server 1. The reservation information DB 14 stores information about the boarding reservation. One record in the reservation information DB 14 is information about one reservation for boarding of one user. A record in the reservation information DB 14 is created by the control unit 12 when a boarding reservation is fixed. A record that is held in the reservation information DB 14 includes fields “reservation ID”, “user ID”, “bus ID”, “scheduled boarding date/time”, “boarding point”, “scheduled alighting date/time”, and “alighting point”.

Identification information of a boarding reservation is stored in the field “reservation ID”. Identification information of a user who is to get on board is stored in the field “user ID”. Identification information of a bus that is to be dispatched in relation to the boarding reservation is stored in “bus ID”. Information pieces about the scheduled boarding date/time, the boarding point, the scheduled alighting date/time, and the alighting point that are established at the time when the reservation is fixed are stored in the fields “scheduled boarding date/time”, “boarding point”, “scheduled alighting date/time”, and “alighting point”, respectively. As the information about the boarding point and the alighting point, latitude and longitude, an address, the name of a landmark, or the like may be used, for example. Additionally, information that is held in the reservation information DB 14 is not limited to the information illustrated in FIG. 4.

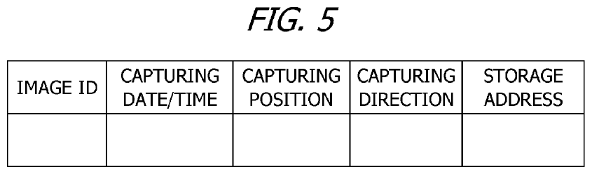

FIG. 5 is an example of the information that is held in the vehicle captured image DB 15 in the server 1. Captured images from the vehicle-mounted cameras on a plurality of vehicles, and information related to the captured images are stored in the vehicle captured image DB 15. FIG. 5 illustrates an example of the information related to the vehicle-mounted camera. The information related to the vehicle-mounted camera includes “image ID”, “capturing date/time”, “capturing position”, “capturing direction”, and “storage address” of the corresponding captured image in the auxiliary storage device 103. The capturing position is indicated by latitude and longitude, or an address, for example.

For example, the captured images from the vehicle-mounted cameras are transmitted to the server 1 from the plurality of vehicles every predetermined period of time. For example, a period of transmission of the captured image from the vehicle-mounted camera is freely set in a range of one second to 10 seconds. A data communication apparatus capable of wireless communication is mounted on a vehicle, for example, and the captured image from the vehicle-mounted camera is transmitted from the data communication apparatus. Information such as the capturing date/time, the capturing position, the capturing direction and the like is also transmitted together with the captured image from the vehicle-mounted camera, for example. When the captured image from the vehicle-mounted camera is received from the vehicle, the control unit 12 generates the information related to the captured image, and holds the captured image in the vehicle captured image DB 15 together with the related information.

The vehicle captured image DB 15 holds captured images that are captured in an immediately preceding predetermined period of time, and older captured images are deleted. Additionally, the predetermined period of time in which the captured images to be held in the vehicle captured image DB 15 are captured is freely set in a range of one day to one month, for example.

In the case of acquiring, from the vehicle captured image DB 15, a captured image to be transmitted to the user terminal 3, the control unit 12 selects a latest captured image among the captured images including the boarding point. For example, the control unit 12 extracts, as the captured image including the boarding point, an image, the capturing position of which is included in a predetermined range of the boarding point of the boarding reservation, where the boarding point is included in the capturing direction from the capturing position. However, such a case is not restrictive, and the method of extracting the captured image including the boarding point may be any known method, for example.

Additionally, captured images from the vehicle-mounted cameras that are received every predetermined period of time and accumulated by an apparatus different from the server 1 may also be used as the vehicle captured image DB 15. Moreover, the information related to the captured image that is held in the vehicle captured image DB 15 is not limited to the example illustrated in FIG. 5.

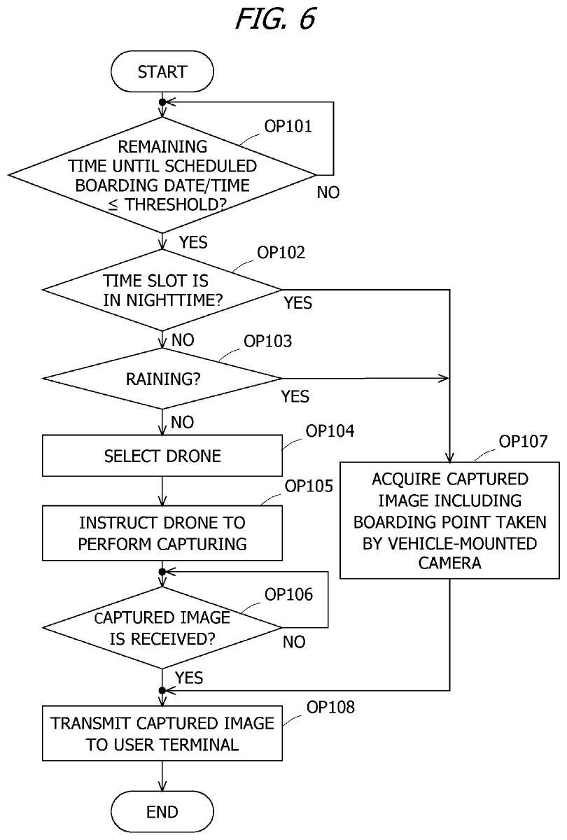

FIG. 6 is an example of a flowchart of the captured image distribution process related to a boarding point by the server 1. The process illustrated in FIG. 6 is performed for one boarding reservation that is not yet processed, or in other words, for each unprocessed record in the reservation information DB 14. The process illustrated in FIG. 6 is started when a boarding reservation is fixed, for example. A main performer of the process illustrated in FIG. 6 is a hardware component such as the CPU 101 of the server 1, but a functional component is described as the performer for the sake of convenience.

In OP101, the control unit 12 determines whether a remaining time to the scheduled boarding date/time is equal to or smaller than a threshold or not. The scheduled boarding date/time is acquired from the reservation information DB 14. In the case where the remaining time to the scheduled boarding date/time is equal to or smaller than the threshold (OP101: YES), the process proceeds to OP102. In the case where the remaining time to the scheduled boarding date/time is greater than the threshold (OP101: NO), the process in OP101 is repeated.

In OP102, the control unit 12 determines whether a current time slot is in the nighttime or not. In the case where the current time slot is in the nighttime (OP102: YES), the drone 2 is not allowed to fly, and the process proceeds to OP107. In the case where the current time slot is a time slot other than the time slot in the nighttime (OP102: NO), the process proceeds to OP103.

In OP103, the control unit 12 determines whether it is currently raining or not. In the case where it is currently raining, the drone 2 is not allowed to fly, and the process proceeds to OP107. In the case where it is currently not raining, the process proceeds to OP104.

In OP104, the control unit 12 selects the drone 2 to be dispatched, by referring to the drone information DB 16. In OP105, the control unit 12 instructs the drone 2 to be dispatched, to move to the boarding point and to capture the boarding point. The drone 2 that is selected thus flies and moves to the boarding point, captures the boarding point from above the boarding point, and transmits the captured image to the server 1.

In OP106, the control unit 12 determines whether the captured image is received from the drone 2 or not. In the case where the captured image is received from the drone 2 (OP106: YES), the process proceeds to OP108. In the case where the captured image is not received from the drone 2 (OP106: NO), the control unit 12 is placed in a standby state until the captured image is received from the drone 2.

In OP107, because the drone 2 is not allowed to fly, the control unit 12 acquires, from the vehicle captured image DB 15, the latest captured image among the captured images including the boarding point.

In OP108, the server 1 transmits, to the user terminal 3, the captured image of the boarding point that is acquired. Then, the process illustrated in FIG. 6 is ended. Additionally, the captured image distribution process related to the boarding point is not limited to the process illustrated in FIG. 6. For example, in the case where the captured image is not received from the drone 2 even when a time that is a predetermined period (such as one minute) before the scheduled boarding date/time is reached, the control unit 12 may determine an error, and may select, from the vehicle captured image DB 15, the image of the boarding point that is to be transmitted to the user terminal 3.

### Operation and Effects of First Embodiment

In the first embodiment, when a time that is a predetermined period before the scheduled boarding date/time of the boarding reservation for the on-demand bus is reached, the image of the boarding point is transmitted to the user terminal 3. The user of the user terminal 3 may reach the boarding point without getting lost by referring to the image of the boarding point.

Furthermore, in the first embodiment, when a time that is a predetermined period before the scheduled boarding date/time of the boarding reservation for the on-demand bus is reached, the drone 2 captures the boarding point, and the captured image that is acquired is transmitted to the user terminal 3. The user of the user terminal 3 may thus grasp the state of the boarding point immediately before boarding, such as how many people are waiting, and may more reliably reach the boarding point.

Furthermore, in the first embodiment, in the case where the drone 2 is not allowed to fly, the latest image of the boarding point among the captured images from the vehicle-mounted cameras is transmitted to the user terminal 3. Accordingly, even in a case where the drone 2 is not allowed to fly, a relatively new captured image of the boarding point may be transmitted to the user terminal 3, and the user of the user terminal 3 may grasp a relatively recent state of the boarding point.

### Other Embodiments

The embodiments described above are examples, and the present disclosure may be changed and carried out as appropriate without departing from the gist of the present disclosure.

In the first embodiment, an example is described where the captured image distribution process related to the boarding point is applied to the on-demand bus system 100. However, the captured image distribution process related to the boarding point is not limited to be applied to the on-demand bus, and may also be applied to transport services, boarding points of which are dynamically set at the time of reservation, such as a ride-sharing service, a taxi, and a vehicle dispatch service, for example.

In the first embodiment, both the captured image from the drone 2 and the captured image from the vehicle-mounted camera are used, but such a case is not restrictive, and a system that uses only one of the captured images is also possible. For example, with a system that uses only the captured image from the drone 2, the server 1 does not have to include the vehicle captured image DB 15, and the captured image of the boarding point does not have to be transmitted to the user terminal 3 in a case where the drone 2 is not allowed to fly. For example, with a system that uses only the captured image from the vehicle-mounted camera, determination of whether the drone 2 is allowed to fly or not is not performed, and the captured image to be transmitted from the user terminal 3 is selected from the vehicle captured image DB 15.

Moreover, as the captured image of the boarding point, an image that is taken by a user of an SNS or the like and that is published on the SNS may also be used, for example. Of the captured images published on the SNS or the like, an image to which position information and the capturing date/time are attached is usable, for example. Such a captured image is treated as big data, and may be acquired from an organization that manages big data, for example.

The captured image from the drone 2 is not limited to be captured from above the boarding point, and may be an image that is captured by the drone 2 that is lowered to a height at around an eye level of a person.

In the first embodiment, the captured image distribution process related to the boarding point is performed when a time that is a predetermined period before the scheduled boarding date/time is reached. However, such a case is not restrictive, and the captured image distribution process related to the boarding point may be performed at a time when a boarding reservation is fixed, for example. An execution timing of the captured image distribution process related to the boarding point is not limited to any predetermined timing.

The processes and means described in the present disclosure may be freely combined to the extent that no technical conflict exists.

A process which is described to be performed by one device may be performed among a plurality of devices. Processes described to be performed by different devices may be performed by one device. Each function to be implemented by a hardware component (server component) in a computer system may be flexibly changed.

The present disclosure may also be implemented by supplying a computer program for implementing a function described in the embodiment above to a computer, and by reading and executing the program by at least one processor of the computer. Such a computer program may be provided to a computer by a non-transitory computer-readable storage medium which is connectable to a system bus of a computer, or may be provided to a computer through a network. The non-transitory computer-readable storage medium may be any type of disk such as a magnetic disk (floppy (registered trademark) disk, a hard disk drive (HDD), etc.), an optical disk (CD-ROM, DVD disk, Blu-ray disk, etc.), a read only memory (ROM), a random access memory (RAM), an EPROM, an EEPROM, a magnetic card, a flash memory, an optical card, and any type of medium which is suitable for storing electronic instructions.

What is claimed is:

1. An information processing apparatus comprising a processor configured to:
acquire a first image that is obtained by capturing a boarding point of a first vehicle provided for a predetermined transport service, and
transmit the first image to a user terminal of a user who is scheduled to get on board the first vehicle at the boarding point.

2. The information processing apparatus according to claim 1, wherein the processor is configured to
issue an instruction to a drone to move to the boarding point, and to capture the first image, and
acquire the first image from the drone.

3. The information processing apparatus according to claim 2, wherein the processor is configured to issue the instruction to the drone in a case where a predetermined condition that allows flight of the drone is satisfied.

4. The information processing apparatus according to claim 3, further comprising a storage configured to hold each of a plurality of captured images together with a capturing date and time and a capturing position, the plurality of captured images being captured by a plurality of vehicle-mounted cameras mounted on a plurality of vehicles, each vehicle-mounted camera capturing the captured image every predetermined period of time that is associated with the each vehicle-mounted camera, wherein
in a case where the predetermined condition is not satisfied, the processor is configured to acquire, as the first image, a latest captured image including the boarding point among the plurality of captured images held in the storage.

5. The information processing apparatus according to claim 3, wherein the predetermined condition is that it is not nighttime and that it is not raining.

6. The information processing apparatus according to claim 1, further comprising a storage configured to hold each of a plurality of captured images together with a capturing date and time and a capturing position, the plurality of captured images being captured by a plurality of vehicle-mounted cameras mounted on a plurality of vehicles every predetermined period of time, wherein
the processor is configured to acquire, as the first image, a latest captured image including the boarding point among the plurality of captured images held in the storage.

7. The information processing apparatus according to claim 1, wherein the processor is configured to acquire the first image and to transmit the first image to the user terminal, in a case where a time that is a predetermined period before a scheduled boarding time of the first vehicle is reached.

8. The information processing apparatus according to claim 7, wherein the boarding point and the scheduled boarding time are determined at a time of reservation for use of the transport service.

9. A method executed by a computer comprising:
acquiring a first image that is obtained by capturing a boarding point of a first vehicle provided for a predetermined transport service; and
transmitting the first image to a user terminal of a user who is scheduled to get on board the first vehicle at the boarding point.

10. The method according to claim 9, wherein the computer
issues an instruction to a drone to move to the boarding point, and to capture the first image, and
acquires the first image from the drone.

11. The method according to claim 10, wherein the computer issues the instruction to the drone in a case where a predetermined condition that allows flight of the drone is satisfied.

12. The method according to claim 11, wherein, in a case where the predetermined condition is not satisfied, the computer acquires, as the first image, a latest captured image including the boarding point among a plurality of captured images that are captured by a plurality of vehicle-mounted cameras mounted on a plurality of vehicles, each vehicle-mounted camera capturing the captured image every predetermined period of time that is associated with the each vehicle-mounted camera, the plurality of captured images being held in a storage configured to hold each of the plurality of captured images together with a capturing date/time and a capturing position.

13. The method according to claim 11, wherein the predetermined condition is that it is not nighttime and that it is not raining.

14. The method according to claim 9, wherein the computer acquires, as the first image, a latest captured image including the boarding point among a plurality of captured images that are captured by a plurality of vehicle-mounted cameras mounted on a plurality of vehicles, each vehicle-mounted camera capturing the captured image every predetermined period of time that is associated with the each vehicle-mounted camera, the plurality of captured images being held in a storage configured to hold each of the plurality of captured images together with a capturing date/time and a capturing position.

15. The method according to claim 9, wherein the computer is caused to acquire the first image and to transmit the first image to the user terminal, in a case where a time that is a predetermined period before a scheduled boarding time of the first vehicle is reached.

16. The method according to claim 15, wherein the boarding point and the scheduled boarding time are determined at a time of reservation for use of the transport service.

17. A system comprising:
a drone; and
an information processing apparatus, wherein
the information processing apparatus includes a processor configured to
issue an instruction to the drone to move to a boarding point of a first vehicle provided for a predetermined transport service, and to capture the boarding point,
acquire a first image obtained by the drone by capturing the boarding point, and
transmit the first image to a user terminal of a user who is scheduled to get on board the first vehicle at the boarding point.

18. The system according to claim 17, wherein the processor is configured to issue the instruction to the drone in a case where a predetermined condition that allows flight of the drone is satisfied.

19. The system according to claim 18, further comprising a storage configured to hold each of a plurality of captured images together with a capturing date/time and a capturing position, the plurality of captured images being captured by a plurality of vehicle-mounted cameras mounted on a plurality of vehicles, each vehicle-mounted camera capturing the captured image every predetermined period of time that is associated with the each vehicle-mounted camera, wherein
in a case where the predetermined condition is not satisfied, the processor is configured to acquire, as the first image, a latest captured image including the boarding point among the plurality of captured images held in the storage.

20. The system according to claim 17, wherein the processor is configured to acquire the first image and to transmit the first image to the user terminal, in a case where a time that is a predetermined period before a scheduled boarding time of the first vehicle is reached.
